(19) United States
(12) Patent Application Publication
(10) Pub. No.: US 2025/0231834 A1
(43) Pub. Date: Jul. 17, 2025

(54) FAILURE COUNT-BASED READ ERROR HANDLING USING LLR DATA

(71) Applicant: Micron Technology, Inc., Boise, ID (US)

(72) Inventor: Phong Sy Nguyen, Livermore, CA (US)

(21) Appl. No.: 19/013,584

(22) Filed: Jan. 8, 2025

Related U.S. Application Data
(60) Provisional application No. 63/620,474, filed on Jan. 12, 2024.

(51) Int. Cl. G06F 11/10

(52) U.S. Cl. CPC G06F 11/1068; G06F 11/1016

(57) ABSTRACT

Various embodiments provide for stripe-based read error handling for a memory system using Log-Likelihood Ratio (LLR) data from a data table selected based on codeword failure count in a stripe.

### PRIORITY APPLICATION

This application claims the benefit of priority to U.S. Provisional Application Ser. No. 63/620,474, filed Jan. 12, 2024, which is incorporated herein by reference in its entirety.

### TECHNICAL FIELD

Example embodiments of the disclosure relate generally to memory devices and, more specifically, to stripe-based read error handling for a memory system, such as a memory sub-system, using Log-Likelihood Ratio (LLR) data from a data table (e.g., from an LLR data table) selected based on codeword failure count in a stripe.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an example computing system that includes a memory sub-system, in accordance with some embodiments of the present disclosure.

FIG. 2 is a diagram illustrating an example stripe that can be used in connection with various embodiments of the present disclosure.

FIG. 3 is a diagram illustrating an example set of distributions of data values stored by a memory cell with respect to hard information and soft information windows, in accordance with various embodiments of the present disclosure.

FIGS. 4 and 5 illustrate flow diagrams of example methods for failure count-based and stripe-based read error handling for a memory system, in accordance with some embodiments of the present disclosure.

FIG. 6 is a table illustrating an example of determining a plurality of difference values for a plurality of data tables and an example of selecting and using data tables in order from smallest to largest difference values, in accordance with some embodiments of the present disclosure.

FIG. 7 is a block diagram of an example computer system in which embodiments of the present disclosure may operate.

### DETAILED DESCRIPTION

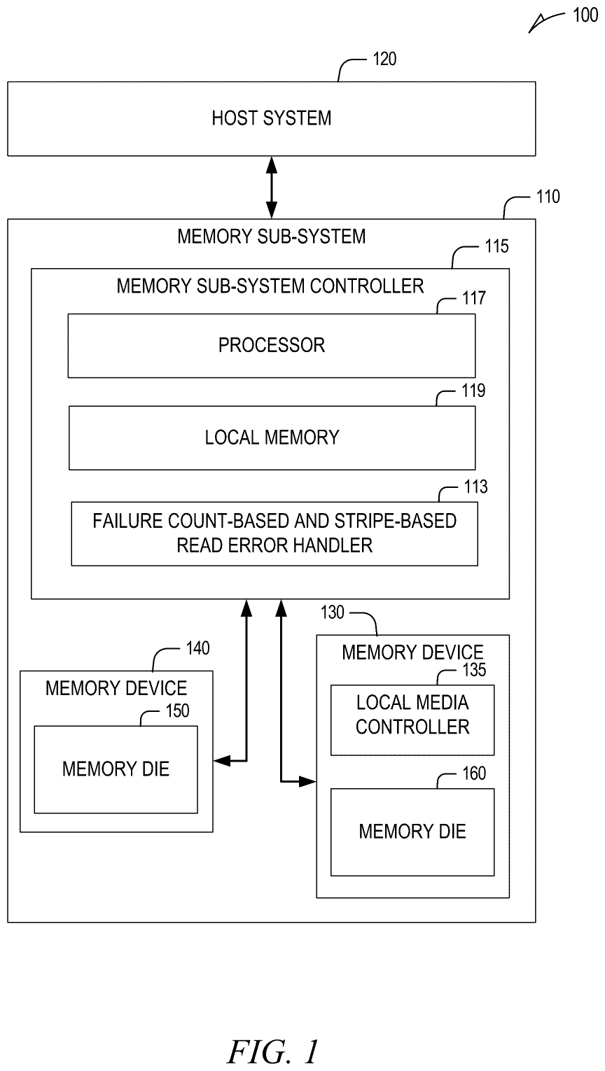

Aspects of the present disclosure are directed to stripe-based read error handling for a memory system, such as a memory sub-system, using Log-Likelihood Ratio (LLR) data from a data table (e.g., from an LLR data table) selected based on codeword failure count in a stripe. Various embodiments described herein can be referred to herein as implementing failure count-based and stripe-based read error handling. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write commands, read commands) to the memory sub-system, such as to store data on a memory device at the memory sub-system, read data from the memory device on the memory sub-system, or write/read constructs with respect to a memory device on the memory sub-system. The data to be read or written, as specified by a host request (e.g., data access request or command request), is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., error-correcting code (ECC) codeword, parity code), data version (e.g., used to distinguish age of data written), valid bitmap (which LBAs or logical transfer units contain valid data), and so forth.

The memory sub-system can initiate media management operations, such as a write operation on host data that is stored on a memory device or a scan (e.g., media scan) of one or more blocks of a memory device. For example, firmware of the memory sub-system can re-write previously written host data from a location of a memory device to a new location as part of garbage collection management operations. The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as an L2P table), data from logging, scratch pad data, and so forth).

A memory device can be a non-volatile memory device. A non-volatile memory device is a package of one or more die. Each die can comprise one or more planes. For some types of non-volatile memory devices (e.g., NOT-AND (NAND)-type devices), each plane comprises a set of physical blocks. For some memory devices, blocks are the smallest area that can be erased. Each block comprises a set of pages. Each page comprises a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package.

Generally, writing data to such memory devices involves programming (by way of a program operation) the memory devices at the page level of a block, and erasing data from such memory devices involves erasing the memory devices at the block level (e.g., page level erasure of data is not possible). Certain memory devices, such as NAND-type memory devices, comprise one or more blocks, (e.g., multiple blocks) with each of those blocks comprising multiple pages, where each page comprises a subset of memory cells of the block, and where a single wordline of a block (which connects a group of memory cells of the block together) defines one or more pages of a block (depending on the type of memory cell). Depending on the embodiment, different blocks can comprise different types of memory cells. For instance, a block (a single-level cell (SLC) block) can comprise multiple SLCs, a block (a multi-level cell (MLC) block) can comprise multiple MLCs, a block (a triple-level cell (TLC) block) can comprise multiple TLCs, a block (a quad-level cell (QLC) block) can comprise QLCs, and a block (a penta-level cell (PLC) block) can comprise PLCs. Other blocks comprising other types of memory cells (e.g., higher-level memory cells, having higher bit storage-per-cell) are also possible.

Each wordline (of a block) can define one or more pages depending on the type of memory cells (of the block) connected to the wordline. For example, for an SLC block, a single wordline can define a single page. For a MLC block, a single wordline can define two pages—a lower page (LP) and an upper page (UP). For a TLC block, a single wordline can define three pages—a lower page (LP), an upper page (UP), and an extra page (XP). For a QLC block, a single wordline can define four pages—a lower page (LP), an upper page (UP), an extra page (XP), and a top page (TP) page. As used herein, a page of LP page type can be referred to as a “LP page,” a page of UP page type can be referred to as a “UP page,” a page of XP page type can be referred to as a “XP page,” and a page of TP page type can be referred to as a “TP page.” Each page type can represent a different level of a cell (e.g., QLC can have a first level for LPs, a second level for UPs, a third level for XPs, and a fourth level for TPs). To write data to a given page, a wordline associated with the given page is programmed according to a page programming algorithm (e.g., that causes one or more voltage pulses or pulses to memory cells of a block based on the memory). Generally, programming a single wordline of a block results all the pages in the single wordline being programmed, where the number pages being programmed depends on the type of block. For example, programming a single wordline of a QLC block usually results in four pages (e.g., LP, UP, XP, TP pages) associated with the single wordline being programmed.

In conventional memory systems (e.g., memory sub-systems), each page of a block (of a memory device) comprises a certain number of codewords, where each codeword comprises a payload portion (or payload) for storing a certain number of data sectors (or sectors) that store data (or host data) from a host system, and where each codeword comprises a non-payload portion that can include protection data (e.g., parity data, such as low-density parity-check (LDPC) data) for protecting (e.g., facilitating error correction) of all the data in the codeword. The non-payload portion can also include protection information, cyclic redundancy check (CRC) data, and metadata (e.g., security metadata and firmware metadata), and the like. For instance, the size of a sector used by a host system can be set to 512 bytes, and NAND-type memory devices can be configured with 16-kilobyte pages each comprising four 4096-byte codewords, and with each codeword comprising a payload that stores eight 512-byte sectors and comprising parity data for facilitating error correction of the host data stored in the payload. Depending on the memory cell type, a reading of a wordline can comprise one or more pages (e.g., 16-kilobyte pages) being read at a given time. For instance, reading a wordline of a SLC block can result in the reading of one 16-kilobyte page, reading a wordline of a MLC block can result in the reading of two 16-kilobyte pages (UP and LP), reading a wordline of a TLC block can result in the reading of three 16-kilobyte pages (UP, LP, XP), and reading a wordline of a QLC block can result in the reading of four 16-kilobyte pages (UP, LP, XP, and TP). A given block (e.g., SLC, MLC, TLC, QLC block) can comprise multiple wordlines.

Different groups of memory cells of a memory device can have different bit error rates in reading the states of the memory cells and thus the data represented by the states. For example, bit error rates can differ from wordline to wordline, from page type to page type, or from die to die. For instance, error rate differences can result from variations in manufacturing processes, or intrinsic properties of the design or layout of circuits on an integrated circuit die. As a result, certain physical memory addresses have better error rates, and other physical memory addresses have worse. The error rates that dictate reliability consideration are from the worst-case stresses the memory device may be subjected to, such as reading and writing at extreme temperatures, or reading after years of being powered off. Overall, the worst error rates can be different based on various factors, such as memory addresses, memory locations (e.g., wordlines), stress (e.g., operating temperature), usage patterns (e.g., power off periods), etc.

To provide reliable error recovery for the worst-performing groups of memory cells, a memory device is usually designed to support storage of sufficient redundant information for each codeword. Additionally, to avoid a memory device having unnecessary memory cells configured for high performance groups of memory cells, the memory device can be designed to provide sufficient support for a majority of memory cell groups to recover bit errors by decoding codewords, and dynamically deploying an additional level of error correction technique for select memory cell groups that have higher bit error rates (to improve error recovery capability of the select memory cell groups). The dynamic error correction technique can comprise dynamically adjusting the amount of redundant information stored in memory cells of a wordline based on a bit error rate of those memory cells. For example, in response to determining that a bit error rate of the wordline is above a threshold value, the memory system can store first data items as independent first codewords of an error correction code technique into a first portion of the memory cells of the wordline, generate second data items as redundant information from the first codewords, and store the second data items in a second portion of the memory cells of the wordline. If the bit error rate is below the threshold value, third data items can be stored as independent second codewords of the same length as the first codewords in the memory cells of the wordline.

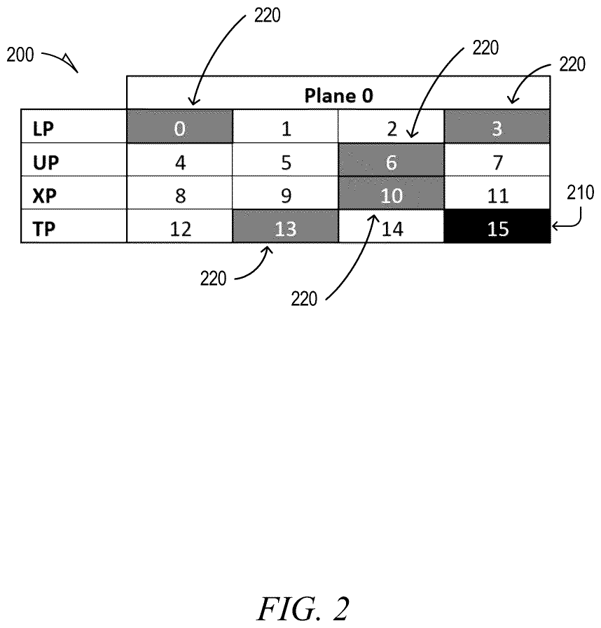

The dynamic error correction technique can be implemented by using dynamic exclusively OR-ing (DynamicXOR) stripes, where parity data (or parity) of each stripe is generated by exclusive OR-ing (XORing) two or more codewords (e.g., translation units) across different page types (of the memory cells) associated with one or more wordlines (e.g., within a single plane within a single NAND die, or across different planes of the single NAND die). Such a dynamic error correction technique can be applied to TLC, QLC, PLC, or other-level-cell (e.g., other multi-bit-per-cell) blocks. The parity data generated can be stored within the same wordline (e.g., as one of the codewords stored on a plane), or stored within another wordline (e.g., in the same block or a different block). FIG. 2 illustrates an example of this error correction technique being used. In particular, codewords (e.g., translation units) 0 through 14 of plane 0 of a NAND die (that comprises QLC blocks) can define a DynamicXOR stripe in FIG. 2, with codeword 15 being used to store parity data for the stripe. At 202, during a write operation, a parity codeword (pCW) (comprising parity data) for a stripe comprising codewords 0 through 14 (CW_0 through CW_14) is generated by XORing codewords 0 through 14 (pCW=CW_0⊕CW_1⊕CW_2⊕CW_3⊕CW_4⊕CW_5⊕CW_6⊕CW_7⊕CW_8⊕CW_9⊕CW_10⊕CW_11⊕CW_12⊕CW_13⊕CW_14) across the pages types (LP, UP, XP, TP) of plane 0, and the resulting parity codeword is stored in codeword 15 (CW15), thereby storing the parity data in the same wordline. It will be understood that other stripes across different page types can also be defined.

Eventually, a reading of a given codeword (e.g., codeword (CW3)) can be requested, such as by a host system (e.g., a host read request comprising a logical memory address that translates to a physical memory address corresponding to the given codeword). Based on the read request, a host system can read a page associated with the given codeword, and attempt to decode the given codeword using a decoding methodology, such as an LDPC decode process (e.g., implemented by an LDPC decoder). If the decode of the (requested) given codeword fails, data recovery of the given codeword can be attempted based on the DynamicXOR stripe. For example, assume codeword 3 (CW3) was requested by a host system and decode (e.g., LDPC decoding) of CW3 failed. At 204, assuming the DynamicXOR stripe comprises codewords 0 through 15 with codeword 15 storing the parity data for the stripe, data recovery can comprise attempting to decode all other codewords of the stripe (CW0 through 2, CW4 through CW14, and CW15), and generating (or updating) a vector (e.g., stripe vector or S vector) by XORing decoded bits (e.g., hard information bits, or hard bits) of passing codewords (e.g., codewords for which decoding succeeded) with un-decoded (raw) bits of failing codewords (e.g., codewords for which decoding initially failed). For example, if we were to assume codewords (e.g., translation units) 0, 3, 6, 10, 13 are failed (e.g., errored) codewords, a vector can be generated (or updated) by XORing decoded bits (e.g., hard information bits, or hard bits) of passing codewords 1, 2, 4, 5, 7, 8, 9, 11, 12, 14, 15 (with codeword storing the previously-generated parity data) and un-decoded (raw) bits of failing codewords 0, 3, 6, 10, 13 as follows: vector=CW_0⊕DECODED (CW_1)⊕DECODED(CW_2)⊕CW_3⊕DECODED(CW_4)⊕DECODED(CW_5)⊕CW_6⊕DECODED(CW_7)⊕DECODED(CW_8)⊕DECODED(CW_9)⊕CW_10⊕DECODED(CW_11)⊕DECODED(CW_12)⊕CW_13⊕DECODED(CW_14)⊕DECODED(CW_15). The resulting vector can be used as an input (e.g., soft information input or soft-input) for decoding (e.g., using LDPC) any of failed codewords 0 through 15 (e.g., codewords 0, 3, 6, 10, 13) of the stripe, such as codeword 3 (CW3). For example, one bit from the resulting vector can be used as soft information-input data (e.g., in addition to soft information-input data) to an LDPC decode process that receives one or more hard information bits and one or more soft information bits with respect to a memory cell.

Conventional methodologies for error correction technique, including using DynamicXOR stripes, can make use of Log-Likelihood Ratio (LLR) data from a Log-Likelihood Ratio (LLR) table. LLR data can comprise a value of measure used to represent a probability, confidence level, or likelihood of a bit that is read from a memory cell of a memory device being a ‘0’ or a ‘1.’ The value of measure from LLR data can comprise a ratio value that compares the probability of a bit being ‘0’ to the probability of it being ‘1’, represented in logarithmic form. In the context of an error correction technique, information (e.g., values of measure) provided by LLR data can provide a way to quantify the reliability of data read from one or more memory cells (of a page or a block) of a memory device. With respect to a bit read by a read operation (e.g., page-level read operation), a higher absolute value of measure from the LLR data can indicate higher confidence in the bit's value as read by the read operation, while a lower absolute value of measure (closer to zero) can indicate uncertainty in the bit's value as read by the read operation. Additionally, a positive value of measure can indicate confidence that the bit is a ‘0’ as read by the read operation, and a negative value of measure can indicate confidence that the bit is a ‘1’ as read by the read operation. When being used with an error correction technique (such as DynamicXOR stripe), LLR data (from an LLR data table) can be provided as soft-input data (e.g., in addition to a stripe vector) to a decode process when attempting to recover decoded data (e.g., decoded hard information data) from a failing codeword, such as an LDPC decode process.

Generally, a data table (or table) that provides LLR data can be referred to as an LLR data table (or LLR table). Depending on the implementation, the table (LLR data table) can comprise a look-up table, which can be configured to provide LLR data (e.g., a value of probability, likelihood, or confidence level) based on a look-up value (e.g., an index value) that comprises hard information data (e.g., 1 hard bit) and soft information data (e.g., 2 soft bits). Where the LLR data is being used for a stripe-based read error handler process (e.g., DynamicXOR stripe), the LLR data table can be configured to provide LLR data based on a look-up value that comprises hard information data (e.g., 1 hard bit), soft information data (e.g., 2 soft bits), and a stripe vector (e.g., s_vector) of an applicable stripe.

Various embodiments presented herein provide for improved stripe-based read error handling for a memory system by enabling use of Log-Likelihood Ratio (LLR) data from a data table (e.g., from an LLR data table) that is selected based on codeword failure count in a stripe. The ability of a stripe-based (e.g., DynamicXOR stripe-based) read error handling to recover one or more failing codewords of a stripe can depend on a number of failing codewords (e.g., translation units) present in the stripe. For example, if a size of a stripe is 16 codewords, a number of failing codewords in the stripe can be any from 1 to 16. Additionally, in the case of the stripe comprising 16 codewords (e.g., translation units) spanning 4 pages in the same wordline, the read bit error rate (RBER) of codewords in the same page tends to be similar, and the likely scenario can be that the number of failed codewords in the wordline is 4, 8, 12, and 16.

In view of this, various embodiments, a stripe-based read error handling process uses LLR data from a plurality of data tables (e.g., LLR data tables), where each data table comprises LLR data configured (e.g., pre-optimized) for use (by stripe-based read error handling process) to decode a failing codeword of the stripe when a certain numbers of failing codewords exist in the stripe, such as 4, 8, 12, and 16 failing codewords (e.g., translation units). As used herein, a targeted codeword failure count can refer to a number of failing codewords for which a given data table comprises LLR data (e.g., LLR data configured or pre-optimized for use when the number of failing codewords exist in a stripe). For example, the plurality of data tables can comprise data tables for each of 4, 8, 12, and 16 failing codewords. According to some embodiments, a current number of codeword failures in a stripe is determined (e.g., obtained), a difference value (e.g., distance value) is determined between the current number of codeword failures and a targeted codeword failure count of each data table of the plurality of data tables, and each determined difference value is associated with its respective data table. For instance, where the current number of codeword failures in the stripe is X, the determined difference values (e.g., distance values) can comprise ABS(X-4), ABS(X-8), ABS(X-12), and ABS(X-16), where ABS stands for absolute value, and where the data table (e.g., targeted) for 4 failing codewords is associated with the difference value ABS(X-4), the data table for 8 failing codewords is associated with the difference value ABS(X-8), the data table for 12 failing codewords is associated with the difference value ABS(X-12), and the data table for 16 failing codewords is associated with the difference value ABS(X-16). For some embodiments, the plurality of data tables is sorted into an order, such as an increasing or decreasing order (e.g., order {ABS(X-4), ABS(X-8), ABS(X-12), ABS(X-16)}), based on their respective difference values. This sorted ordering can assist in successively selecting and using an individual data table (each comprising LLR data for different targeted codeword failure counts), in order from smallest to largest difference value, to decode one or more failing codewords of the stripe until the one or more failing codewords are successfully decoded. In doing so, decoding of one or more failing codewords can be attempted using individual data tables (e.g., 4 data tables for targeted codeword failure counts 4, 8, 12, and 16) of a plurality of data tables successively based on dynamic ordering of the plurality of data tables, which are ordered in view of difference values as determined based on a current count of failing codewords in the stripe and the respective targeted codeword failure counts of the data tables. In the event that a smallest (or next) difference value is associated with two or more data tables (i.e., they have the same single difference value), the data table (in the two or more data tables) associated with the smallest targeted codeword failure count can be selected (e.g., select first) for use in decoding the one or more failing codewords. For some embodiments, individual data tables are successively selected from the two or more data tables and used (to decode the two or more failing codewords of the stripe) in order, from smallest to largest targeted codeword failure count. If the decode of the one or more failing codewords of the stripe is unsuccessful using the two or more data tables, a next data table with a next smallest difference value can be selected and used.

According to some embodiments, a failure count-based read error handling process using LLR data (as described herein) is performed in response to an error being detected during performance of a page-level read operation on a select page (e.g., LP, XP, UP, or TP page of a QLC block) of a memory device (e.g., of a memory sub-system). The page-level operation can be performed (e.g., by a memory sub-system) in response a read request or command, received from a host system, for data (e.g., host data) stored in the select page. The read error handling process can comprise multiple stages, where each stage is attempted/performed consecutively until data can be successfully read from the select page. The failure count-based read error handling process using LLR data, as described herein, can be performed as one of the stages of the (larger) read error handling process.

As used herein, a passing codeword can refer to a codeword that successfully decodes using a decode process (e.g., LDPC) without detection of an error. As used herein, a failing codeword can refer to a codeword that a decode process (e.g., LDPC) fails to decode (e.g., decode process raises a decoding error).

As used herein, a translation unit (TU) of a memory device can comprise (e.g., store) one or more codewords, and can be referenced by a physical memory address (or physical address) of the memory device. For various embodiments, a logical memory address (or logical address) of a memory system is translated into a physical memory address of a memory device.

As used herein, a stripe can comprise a plurality of elements of a memory device, such as pages or codewords (e.g., translation units) of one or more pages, that is grouped together for a read error correction technique (e.g., parity-based error correction). An example of a stripe can include a DynamicXOR stripe as described herein. For example, a DynamicXOR stripe can comprise a plurality of codewords 1 through N that are exclusively-OR'd together to generate parity data (or parity) for the DynamicXOR stripe, where the generated parity can be later used (e.g., to generate a stripe vector that is used) to decode (e.g., assist in decoding) an individual codeword of the dynamic XOR stripe that is failing to decode without an error. Though various embodiments may be described herein with respect to a stripe (e.g., DynamicXOR stripe) that comprises codewords 0 through 14, that has codeword 15 as parity data for the stripe, and that has codewords 0 through 15 stored across pages in a single QLC block (e.g., as shown in FIG. 2), the structure and size of stripes can vary between different embodiments.

As used herein, hard information data (or hard bits) can comprise one or more bits determined based on detecting a voltage charge currently stored (e.g., or held) by a memory cell (of a block of a memory device) and based on one or more hard voltage thresholds (or hard thresholds) associated with the memory cell. For various embodiments, hard information data determined for a memory cell represents a data value actually stored by the memory cell. A hard voltage threshold (or hard threshold) of a memory cell can refer to a discrete voltage threshold level (or discrete threshold level) that separates different ranges (or windows) of voltage charge that the memory cell can store and the different data values represented by each of those different ranges (or windows). For instance, a memory cell of a QLC block can store 4-bits, and can have 16 windows for values (e.g., binary values of 0000 to 1111) separated by 15 discrete threshold levels.

As used herein, soft information data (or soft bits) of a memory cell can comprise one or more bits that indicate where the voltage charge (detected as being stored by a memory cell) lies between two hard thresholds of the memory cell, thereby providing higher-resolution information regarding the voltage charge currently stored by the memory cell (than provided by hard information data alone). Specifically, soft information data can indicate how close a voltage charge sampled/detected from a memory cell is to a hard threshold of the memory cell and, therefore, indicate the probability that the voltage charge (sampled/detected from the memory cell) was sampled/detected correctly. In this way, soft information data can represent the reliability, confidence level, or probability of the hard information data (hard bits) read from one or more memory cells of a memory device, where such the reliability/confidence level/probability can be useful in data error correction techniques. Soft information data can be determined based on detecting a fractional component of a voltage charge currently stored by the memory cell and based on fractional voltage thresholds (e.g., soft thresholds). For instance, where a sampled/detected voltage charge of a memory cell of a TLC block falls between a first voltage threshold and a second voltage threshold, and the hard bits are determined to comprise “101,” the soft bit information (e.g., bit value of “1” or “0”) can indicate whether the sampled/detected voltage charge is closer to the first voltage threshold or the second voltage threshold and the probability of an error in the sampling/detection of the voltage charge. Where hard information data accompanied by soft information data that indicates a voltage charge sampled/detected from a memory cell is close to a hard threshold of the memory cell, that voltage charge has a lower probability of being correct than a voltage charge sampled/detected with soft information that indicates the voltage charge sampled/detected is centered between two hard thresholds. Decode processes (e.g., signal processing algorithms), such as a Low Density Parity Codes (LDPC) process, can use hard information data for a memory cell and soft information data for the memory cell (e.g., in terms of error probabilities) to determine (e.g., decode) a data value stored by the memory cell.

As used herein, undecoded data of a given page of a memory device can comprise undecoded hard information data obtained (e.g., as part of a page-level read operation performed on the given page) for a plurality of memory cells of the memory device that form the given page and store the actual (raw) data of the given page. Undecoded data for a given codeword of the given page can comprise those portions of hard information data that are obtained (from the memory device) for the given page and that correspond to memory cells storing the actual (raw) data of the given codeword.

As used herein, decoded data of a codeword can comprise decoded hard information data generated by successfully decoding the undecoded hard information data of the codeword (e.g., by a decode process or with use of a read error handling when the decode process fails). For some embodiments, a given codeword is decoded by decoding (without error) hard information data of the given codeword using the soft information data of the given codeword (e.g., as soft input to a decode process). In the event an error is encountered during the decoding, a read error handler process (as described herein) can be performed or triggered, which can recover the decoded data from the (failing) codeword using one or more error recovery techniques. An example of hard information data and soft information obtained for one or more memory cells (e.g., a given page or a given codeword) of a memory device can include, without limitation, one hard bit-two soft bit (1H2S) information for each of the memory cells.

Disclosed herein are some examples of stripe-based read error handling for a memory system using Log-Likelihood Ratio (LLR) data from a data table selected based on codeword failure count in a stripe (also referred to as failure count-based and stripe-based read error handling), as described herein.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random-access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130 can include one or more arrays of memory cells. One type of memory cell, for example, SLCs, can store one bit per cell. Other types of memory cells, such as MLCs, TLCs, QLCs, and penta-level cells (PLCs), can store multiple or fractional bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as an MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or another suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands, requests, or operations from the host system 120 and can convert the commands, requests, or operations into instructions or appropriate commands to achieve the desired access to the memory devices 130 and/or the memory device 140. The memory sub-system controller 115 can be responsible for other operations such as wear leveling operations, garbage collection operations, error detection and ECC operations, encryption operations, caching operations, and address translations between a logical address (e.g., LBA, namespace) and a physical memory address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 and/or the memory device 140 as well as convert responses associated with the memory devices 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

Each of the memory devices 130, 140 include a memory die 150, 160. For some embodiments, each of the memory devices 130, 140 represents a memory device that comprises a printed circuit board, upon which its respective memory die 150, 160 is solder mounted.

The memory sub-system controller 115 includes a failure count-based and stripe-based read error handler 113 that enables or facilitates the memory sub-system controller 115 to failure count-based and stripe-based read error handling as described herein. Some or all of the failure count-based and stripe-based read error handler 113 is included by the local media controller 135 to facilitate the implementation of page-level and stripe-based read error handling on the memory sub-system 110 as described herein.

FIG. 2 is a diagram illustrating an example stripe 200 that can be used in connection with various embodiments of the present disclosure. As shown, the stripe 200 is formed by codewords 0 through 14, with codeword 15 (210) storing parity data (or parity) for the stripe. Codewords 0 through 15 are stored across pages LP, UP, XP, TP of a QLC block on plane 0 of the NAND-based memory device die. Codewords 0 through 3 are part of the LP page, codewords 4 through 7 are part of the UP page, codewords 8 through 11 are part of the XP page, and codewords 12 through 15 are part of the TP page. In FIG. 2, codewords 0, 3, 6, 10, 13 can represent failing codewords 220 of the stripe 200.

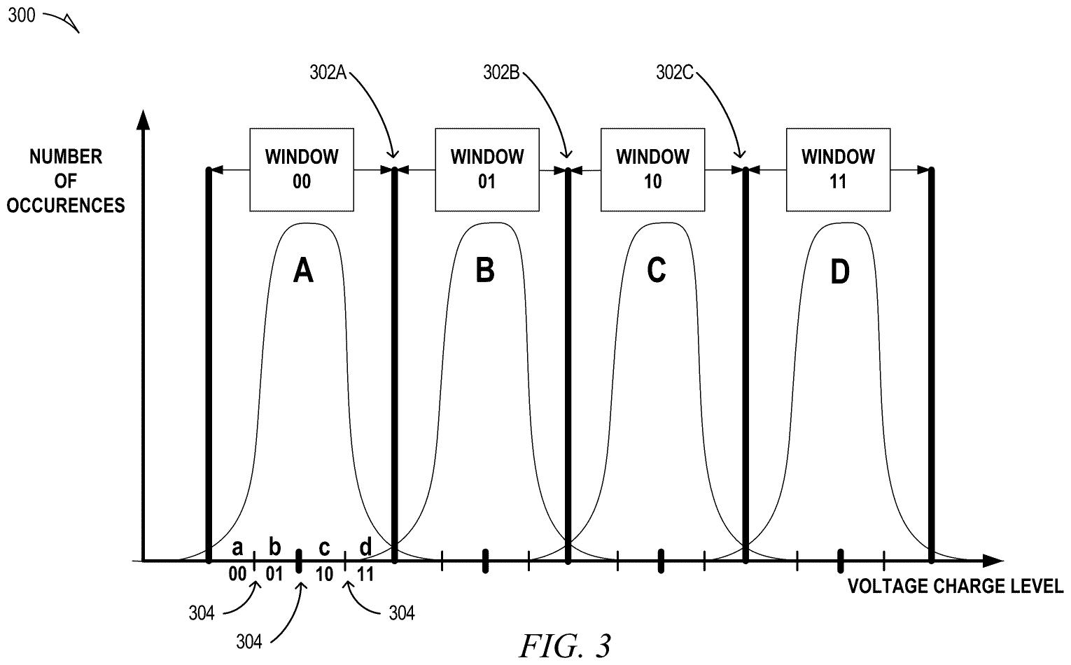

FIG. 3 is a diagram illustrating an example set of distributions 300 of data values stored by a memory cell with respect to hard information and soft information windows, in accordance with various embodiments of the present disclosure. Referring now to FIG. 3, a 2-bit per cell memory device is illustrated as comprising a total of 4 voltage charge ranges, areas or windows of information A-D divided by three threshold levels which are designated as 302A, 302B and 302C. By way of example, a 4-bit per cell device has 16 windows for values to be written with 15 threshold levels separating these values. As described herein, the discrete voltage thresholds separating the information values can be referred to as hard voltage thresholds. Data detection using hard voltage thresholds can be referred to as slicer detection. Data (e.g., bits) represented by hard voltage thresholds can be referred to herein as hard information data (e.g., hard bits). Soft information data (e.g., soft bits) can indicate where a value lies between the hard voltage thresholds and can be referred. Soft information data relates to how close a particular sample is to a hard threshold and therefore to the probability that the voltage sampled was sample/detected correctly. In FIG. 3, each hard information window 00-11 is over sampled with an additional 2 bits of soft information data. The voltage range of each hard information window is divided into four sub-ranges that are designated as a-d for hard window 00. The sub-ranges are separated within each hard window by three soft voltage thresholds 304, a number of which are specifically designated. A total of 16 soft window areas, or 4 bits, are therefore used to describe 2 bits of user data. The number of soft information bits can be extended indefinitely. For instance, a memory cell storing 4-bits of data can be oversampled by 3 additional soft information bits, and can require 7 bits (4 hard information bits and 3 soft information bits) of data to fully describe the 4 bits of data stored by a memory cell. Each hard information window can correspond to a voltage range of the memory cell, and each soft information window can correspond to a voltage sub-range within one of the hard information windows.

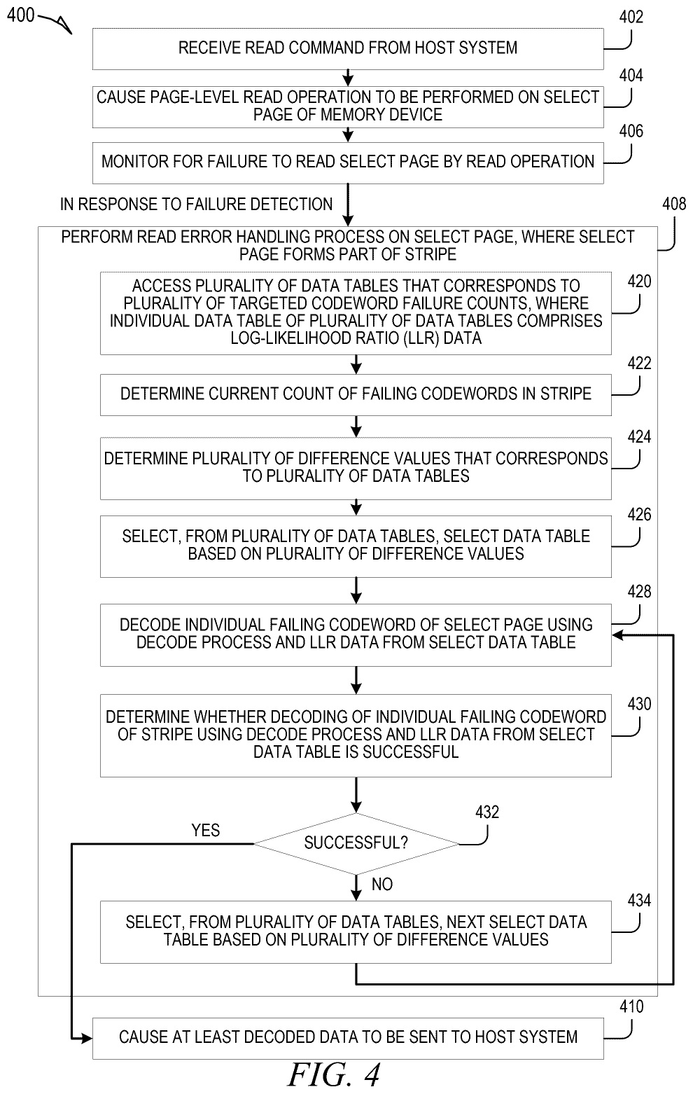

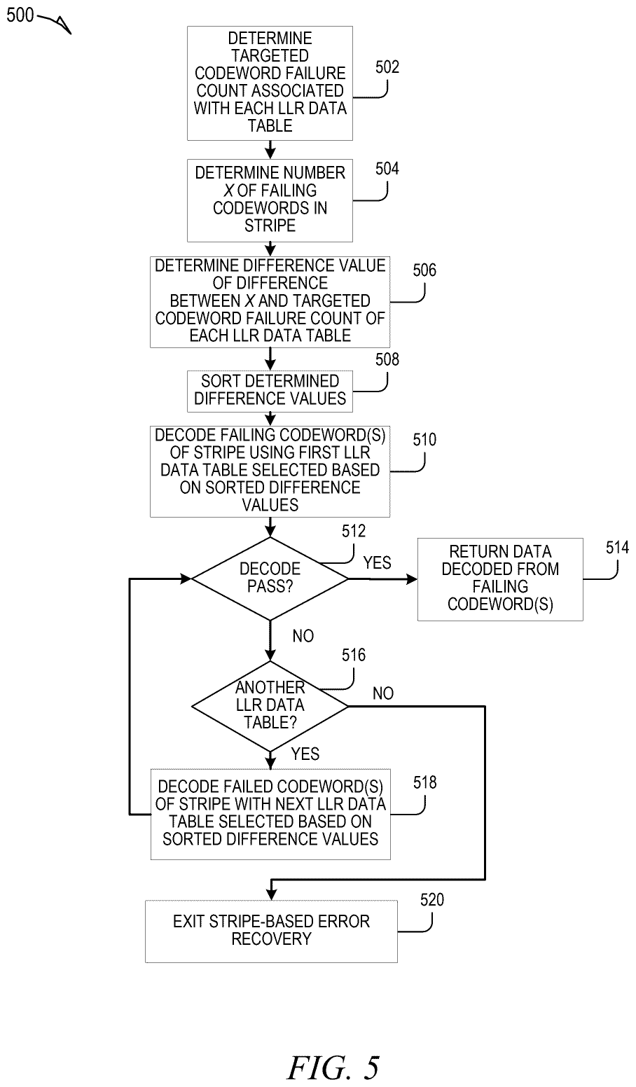

FIGS. 4 and 5 illustrate flow diagrams of example methods 400, 500 for failure count-based and stripe-based read error handling for a memory system, in accordance with some embodiments of the present disclosure. Any of methods 400, 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, one or more of methods 400, 500 is performed by the memory sub-system controller 115 of FIG. 1 based on the page-level and stripe-based read error handler 113. Additionally, or alternatively, for some embodiments, one or more of methods 400, 500 is performed, at least in part, by the local media controller 135 of the memory device 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

Referring now to method 400 of FIG. 4, at operation 402, a processing device (e.g., the processor 117 of the memory sub-system controller 115) receives a read command (e.g., a host read command or request) from a host system (e.g., the host system 120 operatively coupled to the memory sub-system 110). Alternatively, the read command can be one that is internally generated by a memory sub-system, such as for an internal operation (e.g., management operation, such as garbage collection). According to some embodiments, the processing device generates a set of memory operations (e.g., memory media operations) based on the host command received by operation 402.

In response to the read command, at operation 404, the processing device (e.g., the processor 117) causes a page-level read operation to be performed on a select page of a memory device (e.g., 130, 140). The select page can be one of one or more pages from which stored data is being requested by the host system or the memory sub-system (e.g., 110). The page-level read operation can be part of the set of memory operations generated by the processing device based on the read command (e.g., from the host system or internally generated by the memory sub-system). During the page-level operation, undecoded hard information data and soft information data can be obtained for each codeword of the select page.

During the page-level read operation, at operation 406, the processing device (e.g., the processor 117) monitors (e.g., periodically checks) for a failure to read (e.g., a read error is triggered) the select page by the page-level read operation. In response to detecting a failure, at operation 408, the processing device (e.g., the processor 117) performs a read error handling process on the select page of the memory device, where the select page is part of a plurality of pages of the memory device that forms a stripe (e.g., DynamicXOR stripe for DynamicXOR REH). According to some embodiments, the read error handling process represents a failure count-based and stripe-based read error handling process described herein. Additionally, the read error handling process can represent a stage (e.g., a single stage) of a larger, multi-stage read error handling process, which can attempt each read error handling stage consecutively until the data being requested is successfully read. During the read error handling process of operation 408, one or more of operations 420 through 434 can be performed.

At operation 420, the processing device (e.g., the processor 117) accesses a plurality of data tables that corresponds to a plurality of targeted codeword failure counts, where an individual data table of the plurality of data tables comprises Log-Likelihood Ratio (LLR) data configured for decoding one or more failing codewords of the stripe when the stripe has a count of failing codewords equal to an individual targeted codeword failure count corresponding to the individual data table. For some embodiments, each data table is uniquely configured for a different targeted codeword failure count in a stripe. Additionally, for some embodiments, each data table is generated based on testing/experimentation and observation. The plurality of data tables can be generated by a manufacturer of a memory sub-system, and stored on the memory sub-system (e.g., stored in the firmware of the memory sub-system) for subsequent use (e.g., prior to the memory sub-system being shipped to a customer for use).

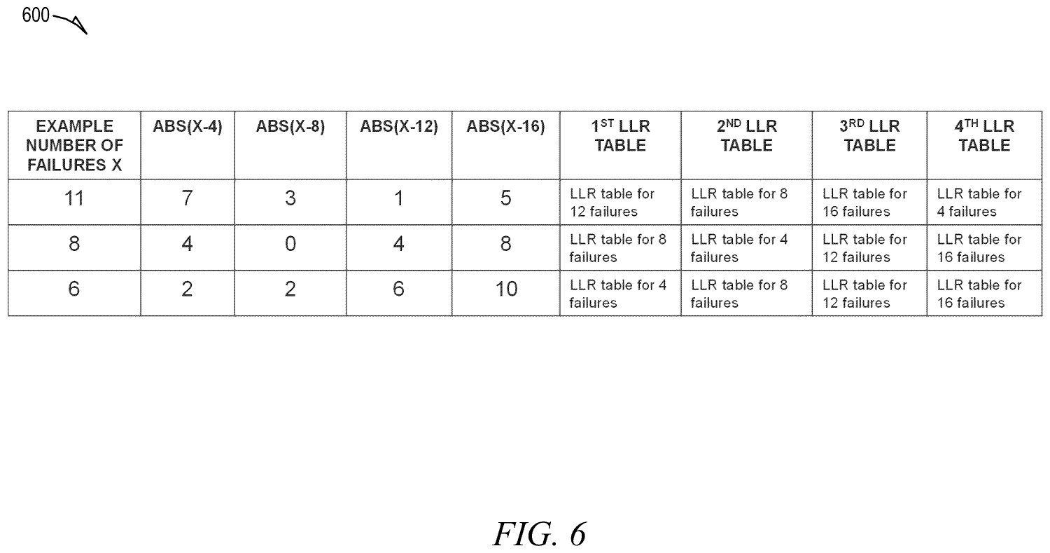

During operation 422, the processing device (e.g., the processor 117) determining a current count of failing codewords in the stripe. For instance, where the stripe comprises 16 codewords, the current count of failing codewords in the stripe can range from 0 to 16. Thereafter, during operation 424, the processing device (e.g., the processor 117) determines a plurality of difference values that corresponds to the plurality of data tables. For various embodiments, determining the plurality of difference values comprises determining, for an individual targeted codeword failure count of the plurality of targeted codeword failure counts that corresponds to an individual data table of the plurality of data tables (e.g., each individual targeted codeword failure count and corresponding individual data table), an individual difference value between the individual targeted codeword failure count and the current count of failing codewords. According to some embodiments, determining the individual difference value comprises determining an absolute value of subtracting the individual targeted codeword failure count from the current count of failing codewords. An example of determining a plurality of difference values for a plurality of data tables is illustrated and described with respect to FIG. 6.

At operation 426, the processing device (e.g., the processor 117) selects (e.g., identifies), from the plurality of data tables, a select data table based on the plurality of difference values (determined by operation 424). For some embodiments, operation 426 comprises the processing device determining, in the plurality of data tables, a single data table corresponding to a smallest difference value in the plurality of difference values, the single data table being the select data table. Additionally, for some embodiments, operation 426 comprises the processing device determining, in the plurality of data tables, a set of data tables corresponding to a smallest difference value in the plurality of difference values, and determining whether the set of data tables comprises more than one data table. In response to determining that the set of data tables comprises more than the single data table, the processing device can determine, in the set of data tables, a single data table corresponding to a smallest targeted codeword failure count and can select the single data table as the select data table. Alternatively, in response to determining that the set of data tables comprises no more than one data table, the processing device can select a single data table of the set of data tables as the select data table.

According to some embodiments, operation 426 comprises generating a sorted plurality of data tables by sorting the plurality of data tables based on the plurality of difference values. For instance, the plurality of data tables can be sorted in descending (or ascending) order based on the plurality of different values. Thereafter, the processing device can determine, in the sorted plurality of data tables, a single data table corresponding to a smallest difference value in the plurality of difference values, where the single data table is used as the select data table.

For operation 428, the processing device (e.g., the processor 117) decodes (e.g., attempts to decode) an individual failing codeword of the stripe using a decode process and LLR data from the select data table (selected by operation 426). An example of the decode process can include, without limitation, a low-density parity-check (LDPC) decode process. For some embodiments, during operation 428, at least a portion of the LLR data is used as soft-input data to the decode process (e.g., LDPC decode process). For some embodiments, operation 428 comprises using the decode process to decode the individual failing codeword, where at least some portion of the LLR data, the stripe vector, and the soft information data of the individual failing codeword are used as soft-input data of the decode process, and the undecoded hard information data of the individual failing codeword is used as hard-input data of the decode process.

As part of operation 428, the processing device obtains the LLR data from the select data table (e.g., lookup data table). To obtain the LLR data from the select data table (e.g., lookup data table), the processing device can generate a lookup value for the select data table, and can use the generated lookup value to obtain (e.g., search for or identify) the LLR data I the select data table. For example, the processing device can generate a stripe vector for the stripe based on decoded hard information data of one or more passing codewords of the stripe and based on undecoded hard information data of one or more failing codewords of the stripe, and can identify (and then obtain) the LLR data in the select data table based on the stripe vector (e.g., using the stripe vector as a lookup index value). Additionally, for example, the processing device can generate a stripe vector for the stripe based on decoded hard information data of one or more passing codewords of the stripe and based on undecoded hard information data of one or more failing codewords of the stripe, and can identify (and then obtain) the LLR data in the select data table on the stripe vector, undecoded hard information of the individual failing codeword, and soft information of the individual failing codeword. For instance, a combination of the stripe vector, undecoded hard information (e.g., from 1H2S data) of the individual failing codeword, and soft information (e.g., from 1H2S data) of the individual failing codeword as a lookup index value.

At operation 430, the processing device (e.g., the processor 117) determines whether the decoding of the individual failing codeword of the stripe using the decode process and the LLR data from the first select data table is successful. At operation 432, in response to the processing device determining that the decoding of the individual failing codeword (at operation 430) is not successful, method 400 proceeds to operation 434, otherwise method 400 proceeds to operation 410, where the processing device causes at least the decoded data (e.g., of the decoded hard information data) of the individual failing codeword of the select page to be sent (or otherwise provided) to the host system (or an internal requestor of the memory sub-system).

During operation 434, the processing device (e.g., the processor 117) selects, from the plurality of data tables, a next (e.g., second) select data table based on the plurality of difference values. For various embodiments, the next select data table selected by operation 434 is a data table of the plurality of data tables that corresponds to a next smallest difference value (following the difference value of the data table last used by operation 428). Additionally, where no additional data tables remain for use (e.g., all data tables of the plurality have been used by operation 428), operation 408 can end, and method 400 can proceed to another read error handling process or issue a failure to recover data from the select page via a read error handling. From operation 434, method 400 can proceed to operation 428, where the processing device decodes (e.g., attempts to decode) the individual failing codeword of the stripe using the decode process and LLR data from the next select data table (selected by operation 434). An example of selecting data tables, in order from smallest to largest difference values, is illustrated and described with respect to FIG. 6. By way of operations 428 through 434, various embodiments can perform one or more iterations of using different data tables of the plurality of data tables in successive order (e.g., from smallest to largest difference value).

Referring now to FIG. 5, method 500 represents an example implementation of method 400 of FIG. 4. At operation 502, the processing device (e.g., the processor 117) determines a targeted codeword failure count associated with each LLR data table. For instance, the LLR data tables can comprise LLR_TABLE(T₁) through LLR_TABLE(T_{M}), where the value of T for an LLR data table indicates the targeted codeword (e.g., translation unit) failure count associated with the LLR data contained by that LLR data table. At operation 504, the processing device determines a number X of failing codewords currently in a stripe (e.g., DynamicXOR stripe). During operation 506, the processing device generates a plurality of differences values (e.g., absolute values) by determining an absolute value of difference between X and the targeted codeword failure count T of each LLR data table (e.g., {ABS(X-T₁), . . . , ABS(X-T_{M})}). The processing device, at operation 508, sorts the plurality of difference values according to an order), such as descending order or ascending order. For example, if {ABS(X-T₁), . . . , ABS(X-T_{M})} is sorted in ascending order, the resulting order can be {ABS(X-O₁), . . . , ABS(X-O_{M})}, where O represents the values of T after being placed in the ascending order such that ABS(X-O₁)≤ABS(X-O₂)≤ . . . ≤ABS(X-O_{M}), thereby ordering the difference values from smallest to largest. Thereafter, at operation 510, the processing device decodes (e.g., attempts to decode) one or more failing codewords of the stripe using a first LLR data table selected based on the sorted plurality of difference values (e.g., if ordered in ascending order, the first LLR data table selected is LLR_TABLE(O₁)).

If the processing device determines at operation 512 that the decode passed, method 500 proceeds to operation 514, where data decoded from one or more failing codewords (decoded using LLR data from a selected LLR data table) are returned or provided, such as to a host system or an internal requestor of a memory sub-system. If, however, the processing device determines at operation 512 that the decode has not passed, method 500 proceeds to operation 516. At operation 516, the processing device determines whether another LLR data table (not previously used by method 500) remains for use. If the processing device determines at operation 516 that another LLR data table does not remain for use, method 500 proceeds to operation 520, where the processing devices can cause the stripe-based error recovery to exit. However, if the processing device determines at operation 516 that another LLR data table does remain for use, method 500 proceeds to operation 518, where the processing device decodes (e.g., attempts to decode) the one or more failing codewords of the stripe using a next LLR data table selected based on the sorted plurality of difference values (e.g., if ordered in ascending order, the last LLR data table selected is LLR_TABLE(O_{P}), the next LLR data table select is LLR_TABLE (O_{P+1})). From operation 518, method 500 returns to operation 512.

FIG. 6 is a table 600 illustrating an example of determining a plurality of difference values for a plurality of data tables and an example of selecting and using data tables in order from smallest to largest difference values, in accordance with some embodiments of the present disclosure. In particular, the examples are illustrate scenarios where a stripe contains 11, 8, and 6 codeword failures respectively. Assuming that there are 4 data tables (e.g., LLR data tables) comprising LLR data configured for use when there is 4 codeword failures, 8 codeword failures, 12 codeword failures, and 16 codeword failures, the difference values for each of those LLR data tables can be determined for each of failure scenarios. As shown for 11 codeword failures, the difference values (ABS(X-4), ABS(X-8), ABS(X-12), and ABS(X-16)) are: 7 for the data table for 4 codeword failures; 3 for the data table for 8 codeword failures; 1 for the data table for 12 codeword failures; and 5 for the data table for 16 codeword failures. Table 600 shows similar distance values determined for the other codeword failure scenarios (8 codeword failures and 6 codeword failures).

Continuing with the scenario of 11 codeword failures, based on the determined difference values, an embodiment described herein can select the data table for 12 codeword failures first for decode use (based on its difference value of 1), the data table for 8 codeword failures second for decode use (based on its difference value of 3), the data table for 16 codeword failures third for decode use (based on its difference value of 5), and the data table for 4 codeword failures last for decode use (based on its difference value of 7). Table 600 shows how the order in which the 4 data tables are selected changes for the other codeword failure scenarios (8 codeword failures and 6 codeword failures).

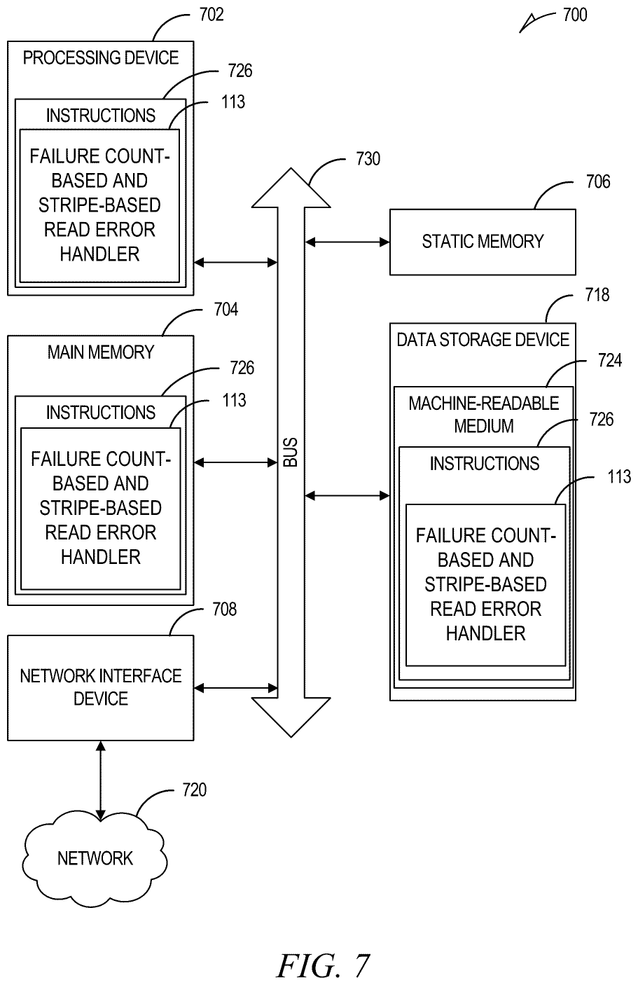

FIG. 7 illustrates an example machine in the form of a computer system 700 within which a set of instructions can be executed for causing the machine to perform any one or more of the methodologies discussed herein. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., ROM, flash memory, DRAM such as SDRAM or Rambus DRAM (RDRAM), etc.), a static memory 706 (e.g., flash memory, static random access memory (SRAM), etc.), and a data storage device 718, which communicate with each other via a bus 730.

The processing device 702 represents one or more general-purpose processing devices such as a microprocessor, a central processing unit, or the like. More particularly, the processing device 702 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 702 can also be one or more special-purpose processing devices such as an application-specific integrated circuit (ASIC), a field programmable gate array (FPGA), a digital signal processor (DSP), a network processor, or the like. The processing device 702 is configured to execute instructions 726 for performing the operations and steps discussed herein. The computer system 700 can further include a network interface device 708 to communicate over a network 720.

The data storage device 718 can include a machine-readable storage medium 724 (also known as a computer-readable medium) on which is stored one or more sets of instructions 726 or software embodying any one or more of the methodologies or functions described herein. For some embodiments, the machine-readable storage medium 724 is a non-transitory machine-readable storage medium. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage device 718, and/or main memory 704 can correspond to the memory sub-system 110 of FIG. 1.

In one embodiment, the instructions 726 include instructions to implement functionality corresponding to failure count-based and stripe-based read error handling on a memory system as described herein (e.g., the failure count-based and stripe-based read error handler 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory device; and a processing device, operatively coupled to the memory device, configured to perform operations, the operations comprising performing a read error handling process on a select page of the memory device, the select page being part of a plurality of pages of the memory device that forms a stripe, the read error handling process comprising: accessing a plurality of data tables that corresponds to a plurality of targeted codeword failure counts, an individual data table of the plurality of data tables comprising Log-Likelihood Ratio (LLR) data configured for decoding one or more failing codewords of the stripe when the stripe has a count of failing codewords equal to an individual targeted codeword failure count corresponding to the individual data table; determining a current count of failing codewords in the stripe; determining a plurality of difference values that corresponds to the plurality of data tables, the determining of the plurality of difference values comprising determining, for an individual targeted codeword failure count of the plurality of targeted codeword failure counts that corresponds to an individual data table of the plurality of data tables, an individual difference value between the individual targeted codeword failure count and the current count of failing codewords; selecting, from the plurality of data tables, a select data table based on the plurality of difference values; and decoding an individual failing codeword of the select page using a decode process and LLR data from the select data table.

In Example 2, the subject matter of Example 1 includes, wherein the decoding of the individual failing codeword of the select page using the decode process and the LLR data from the select data table comprises using at least a portion of the LLR data as soft-input data to the decode process.

In Example 3, the subject matter of Examples 1-2 includes, wherein the decoding of the individual failing codeword of the select page using the decode process and the LLR data from the select data table comprises: generating a stripe vector for the stripe based on decoded hard information data of one or more passing codewords of the stripe and based on undecoded hard information data of one or more failing codewords of the stripe; and identifying the LLR data in the select data table based on the stripe vector.

In Example 4, the subject matter of Examples 1-3 includes, wherein the decoding of the individual failing codeword of the select page using the decode process and the LLR data from the select data table comprises: generating a stripe vector for the stripe based on decoded hard information data of one or more passing codewords of the stripe and based on undecoded hard information data of one or more failing codewords of the stripe; and identifying the LLR data in the select data table based on the stripe vector, undecoded hard information of the individual failing codeword, and soft information of the individual failing codeword.

In Example 5, the subject matter of Example 4 includes, wherein the decoding of the individual failing codeword of the select page using the decode process and the LLR data from the select data table comprises: using the decode process to decode the individual failing codeword, at least some portion of the LLR data, the stripe vector, and the soft information data of the individual failing codeword being used as soft-input data of the decode process, the undecoded hard information data of the individual failing codeword being used as hard-input data of the decode process.

In Example 6, the subject matter of Examples 1-5 includes, wherein the determining of the individual difference value comprises determining an absolute value of subtracting the individual targeted codeword failure count from the current count of failing codewords.

In Example 7, the subject matter of Examples 1-6 includes, wherein the selecting of the select data table, from the plurality of data tables, based on the plurality of difference values comprises: determining, in the plurality of data tables, a single data table corresponding to a smallest difference value in the plurality of difference values, the single data table being the select data table.

In Example 8, the subject matter of Examples 1-7 includes, wherein the selecting of the select data table, from the plurality of data tables, based on the plurality of difference values comprises: determining, in the plurality of data tables, a set of data tables corresponding to a smallest difference value in the plurality of difference values; determining whether the set of data tables comprises more than one data table; in response to determining that the set of data tables comprises no more than one data table, selecting a single data table of the set of data tables as the select data table; and in response to determining that the set of data tables comprises more than the single data table: determining, in the set of data tables, a single data table corresponding to a smallest targeted codeword failure count; and selecting the single data table as the select data table.

In Example 9, the subject matter of Examples 1-8 includes, wherein the selecting of the select data table, from the plurality of data tables, based on the plurality of difference values comprises: generating a sorted plurality of data tables by sorting the plurality of data tables based on the plurality of difference values; and determining, in the sorted plurality of data tables, a single data table corresponding to a smallest difference value in the plurality of difference values, the single data table being the select data table.

In Example 10, the subject matter of Examples 1-9 includes, wherein the select data table is a first select data table, and wherein the operations comprise: determining whether the decoding of the individual failing codeword of the select page using the decode process and the LLR data from the first select data table is successful; and in response to determining that the decoding of the individual failing codeword of the select page using the decode process and the LLR data from the first select data table is not successful: selecting, from the plurality of data tables, a second select data table based on the plurality of difference values; and decoding the individual failing codeword of the select page using the decode process and LLR data from the second select data table.

In Example 11, the subject matter of Example 10 includes, wherein the first select data table is selected based on a first difference value in the plurality of difference values corresponding to the first select data table being a first smallest difference value in the plurality of difference values, and wherein the second select data table is selected based on a second difference value in the plurality of difference values corresponding to the second select data table being a second smallest difference value in the plurality of difference values.

In Example 12, the subject matter of Examples 1-11 includes, wherein the selecting of the select data table based on the plurality of difference values, and the decoding of the individual failing codeword of the select page using the decode process and the LLR data from the select data table, comprises: generating a sorted plurality of data tables by sorting the plurality of data tables based on the plurality of difference values; determining, in the sorted plurality of data tables, a first data table corresponding to a first smallest difference value in the plurality of difference values, the first data table being the select data table; and performing an iteration that comprises: decoding the individual failing codeword of the select page using a decode process and LLR data from the select data table to generate decoded data of the individual failing codeword; determining whether the decoding of the individual failing codeword of the select page using the decode process and the LLR data from the select data table is successful; and in response to determining that the decoding of the individual failing codeword of the select page using the decode process and the LLR data from the select data table is not successful: determining, in the plurality of data tables, a next data table corresponding to a next smallest difference value in the plurality of difference values; and causing the iteration to repeat in response to determining the next data table, the next data table being the select data table.

In Example 13, the subject matter of Examples 1-12 includes, wherein the selecting of the select data table based on the plurality of difference values, and the decoding of the individual failing codeword of the select page using the decode process and the LLR data from the select data table, comprises: generating a sorted plurality of data tables by sorting the plurality of data tables based on the plurality of difference values; determining, in the sorted plurality of data tables, a first data table corresponding to a first smallest difference value in the plurality of difference values, the first data table being the select data table; and performing an iteration that comprises: decoding the individual failing codeword of the select page using a decode process and LLR data from the select data table to generate decoded data of the individual failing codeword; determining whether the decoding of the individual failing codeword of the select page using the decode process and the LLR data from the select data table is successful; and in response to determining that the decoding of the individual failing codeword of the select page using the decode process and the LLR data from the select data table is successful, at least one of: causing at least the decoded data of the individual failing codeword of the select page to be sent to a host system; or decoding another individual failing codeword of the select page using the decode process and the LLR data from the select table.

In Example 14, the subject matter of Examples 1-13 includes, wherein the plurality of data tables is generated and stored on the system by a manufacturer of the system.

In Example 15, the subject matter of Examples 1-14 includes, wherein the operations comprise: causing a page-level read operation to be performed on the select page; and monitoring for a failure to read the select page by the page-level read operation, the read error handling process being performed on the select page in response to a failure to read the select page by the page-level read operation.

In Example 16, the subject matter of Examples 1-15 includes, wherein the decode process comprises a low-density parity-check (LDPC) decode process.

Example 17 is at least one machine-readable medium including instructions that, when executed by a processing device of a memory sub-system, cause the processing device to perform operations to implement of any of Examples 1-16.

Example 18 is a method to implement of any of Examples 1-16.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (e.g., non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, configured to perform operations, the operations comprising performing a read error handling process on a select page of the memory device, the select page being part of a plurality of pages of the memory device that forms a stripe, the read error handling process comprising:
accessing a plurality of data tables that corresponds to a plurality of targeted codeword failure counts, an individual data table of the plurality of data tables comprising Log-Likelihood Ratio (LLR) data configured for decoding one or more failing codewords of the stripe when the stripe has a count of failing codewords equal to an individual targeted codeword failure count corresponding to the individual data table;
determining a current count of failing codewords in the stripe;
determining a plurality of difference values that corresponds to the plurality of data tables, the determining of the plurality of difference values comprising determining, for an individual targeted codeword failure count of the plurality of targeted codeword failure counts that corresponds to an individual data table of the plurality of data tables, an individual difference value between the individual targeted codeword failure count and the current count of failing codewords;
selecting, from the plurality of data tables, a select data table based on the plurality of difference values; and
decoding an individual failing codeword of the select page using a decode process and LLR data from the select data table.

2. The system of claim 1, wherein the decoding of the individual failing codeword of the select page using the decode process and the LLR data from the select data table comprises using at least a portion of the LLR data as soft-input data to the decode process.

3. The system of claim 1, wherein the decoding of the individual failing codeword of the select page using the decode process and the LLR data from the select data table comprises:
generating a stripe vector for the stripe based on decoded hard information data of one or more passing codewords of the stripe and based on undecoded hard information data of one or more failing codewords of the stripe; and
identifying the LLR data in the select data table based on the stripe vector.

4. The system of claim 1, wherein the decoding of the individual failing codeword of the select page using the decode process and the LLR data from the select data table comprises:
generating a stripe vector for the stripe based on decoded hard information data of one or more passing codewords of the stripe and based on undecoded hard information data of one or more failing codewords of the stripe; and
identifying the LLR data in the select data table based on the stripe vector, undecoded hard information of the individual failing codeword, and soft information of the individual failing codeword.

5. The system of claim 4, wherein the decoding of the individual failing codeword of the select page using the decode process and the LLR data from the select data table comprises:
using the decode process to decode the individual failing codeword, at least some portion of the LLR data, the stripe vector, and the soft information data of the individual failing codeword being used as soft-input data of the decode process, the undecoded hard information data of the individual failing codeword being used as hard-input data of the decode process.

6. The system of claim 1, wherein the determining of the individual difference value comprises determining an absolute value of subtracting the individual targeted codeword failure count from the current count of failing codewords.

7. The system of claim 1, wherein the selecting of the select data table, from the plurality of data tables, based on the plurality of difference values comprises:
determining, in the plurality of data tables, a single data table corresponding to a smallest difference value in the plurality of difference values, the single data table being the select data table.

8. The system of claim 1, wherein the selecting of the select data table, from the plurality of data tables, based on the plurality of difference values comprises:
determining, in the plurality of data tables, a set of data tables corresponding to a smallest difference value in the plurality of difference values;
determining whether the set of data tables comprises more than one data table;
in response to determining that the set of data tables comprises no more than one data table, selecting a single data table of the set of data tables as the select data table; and
in response to determining that the set of data tables comprises more than the single data table:
determining, in the set of data tables, a single data table corresponding to a smallest targeted codeword failure count; and
selecting the single data table as the select data table.

9. The system of claim 1, wherein the selecting of the select data table, from the plurality of data tables, based on the plurality of difference values comprises:
generating a sorted plurality of data tables by sorting the plurality of data tables based on the plurality of difference values; and
determining, in the sorted plurality of data tables, a single data table corresponding to a smallest difference value in the plurality of difference values, the single data table being the select data table.

10. The system of claim 1, wherein the select data table is a first select data table, and wherein the operations comprise:
determining whether the decoding of the individual failing codeword of the select page using the decode process and the LLR data from the first select data table is successful; and
in response to determining that the decoding of the individual failing codeword of the select page using the decode process and the LLR data from the first select data table is not successful:
selecting, from the plurality of data tables, a second select data table based on the plurality of difference values; and
decoding the individual failing codeword of the select page using the decode process and LLR data from the second select data table.

11. The system of claim 10, wherein the first select data table is selected based on a first difference value in the plurality of difference values corresponding to the first select data table being a first smallest difference value in the plurality of difference values, and wherein the second select data table is selected based on a second difference value in the plurality of difference values corresponding to the second select data table being a second smallest difference value in the plurality of difference values.

12. The system of claim 1, wherein the selecting of the select data table based on the plurality of difference values, and the decoding of the individual failing codeword of the select page using the decode process and the LLR data from the select data table, comprises:
generating a sorted plurality of data tables by sorting the plurality of data tables based on the plurality of difference values;
determining, in the sorted plurality of data tables, a first data table corresponding to a first smallest difference value in the plurality of difference values, the first data table being the select data table; and
performing an iteration that comprises:
decoding the individual failing codeword of the select page using a decode process and LLR data from the select data table to generate decoded data of the individual failing codeword;
determining whether the decoding of the individual failing codeword of the select page using the decode process and the LLR data from the select data table is successful; and
in response to determining that the decoding of the individual failing codeword of the select page using the decode process and the LLR data from the select data table is not successful:
determining, in the plurality of data tables, a next data table corresponding to a next smallest difference value in the plurality of difference values; and
causing the iteration to repeat in response to determining the next data table, the next data table being the select data table.

13. The system of claim 1, wherein the selecting of the select data table based on the plurality of difference values, and the decoding of the individual failing codeword of the select page using the decode process and the LLR data from the select data table, comprises:
generating a sorted plurality of data tables by sorting the plurality of data tables based on the plurality of difference values;
determining, in the sorted plurality of data tables, a first data table corresponding to a first smallest difference value in the plurality of difference values, the first data table being the select data table; and
performing an iteration that comprises:
decoding the individual failing codeword of the select page using a decode process and LLR data from the select data table to generate decoded data of the individual failing codeword;
determining whether the decoding of the individual failing codeword of the select page using the decode process and the LLR data from the select data table is successful; and
in response to determining that the decoding of the individual failing codeword of the select page using the decode process and the LLR data from the select data table is successful, at least one of:
causing at least the decoded data of the individual failing codeword of the select page to be sent to a host system; or
decoding another individual failing codeword of the select page using the decode process and the LLR data from the select table.

14. The system of claim 1, wherein the plurality of data tables is generated and stored on the system by a manufacturer of the system.

15. The system of claim 1, wherein the operations comprise:
causing a page-level read operation to be performed on the select page; and
monitoring for a failure to read the select page by the page-level read operation, the read error handling process being performed on the select page in response to a failure to read the select page by the page-level read operation.

16. The system of claim 1, wherein the decode process comprises a low-density parity-check (LDPC) decode process.

17. At least one non-transitory machine-readable storage medium comprising instructions that, when executed by a processing device of a memory sub-system, cause the processing device to perform operations comprising:
accessing a plurality of data tables that corresponds to a plurality of targeted codeword failure counts, an individual data table of the plurality of data tables comprising Log-Likelihood Ratio (LLR) data configured for decoding one or more failing codewords of a stripe when a stripe has a count of failing codewords equal to an individual targeted codeword failure count corresponding to the individual data table, the stripe being formed by a plurality of pages of a memory device of the memory sub-system;
determining a current count of failing codewords in the stripe;
determining a plurality of difference values that corresponds to the plurality of data tables, the determining of the plurality of difference values comprising determining, for an individual targeted codeword failure count of the plurality of targeted codeword failure counts that corresponds to an individual data table of the plurality of data tables, an individual difference value between the individual targeted codeword failure count and the current count of failing codewords;
selecting, from the plurality of data tables, a select data table based on the plurality of difference values; and
decoding an individual failing codeword of a select page the plurality of pages using a decode process and LLR data from the select data table.

18. The at least one non-transitory machine-readable storage medium of claim 17, wherein the decoding of the individual failing codeword of the select page using the decode process and the LLR data from the select data table comprises:
generating a stripe vector for the stripe based on decoded hard information data of one or more passing codewords of the stripe and based on undecoded hard information data of one or more failing codewords of the stripe; and
identifying the LLR data in the select data table based on the stripe vector.

19. The at least one non-transitory machine-readable storage medium of claim 17, wherein the selecting of the select data table, from the plurality of data tables, based on the plurality of difference values comprises:
determining, in the plurality of data tables, a single data table corresponding to a smallest difference value in the plurality of difference values, the single data table being the select data table.

20. A method comprising:
accessing a plurality of data tables that corresponds to a plurality of targeted codeword failure counts, an individual data table of the plurality of data tables comprising Log-Likelihood Ratio (LLR) data configured for decoding one or more failing codewords of a stripe when a stripe has a count of failing codewords equal to an individual targeted codeword failure count corresponding to the individual data table, the stripe being formed by a plurality of pages of a memory device of a memory sub-system;
determining a current count of failing codewords in the stripe;
determining a plurality of difference values that corresponds to the plurality of data tables, the determining of the plurality of difference values comprising determining, for an individual targeted codeword failure count of the plurality of targeted codeword failure counts that corresponds to an individual data table of the plurality of data tables, an individual difference value between the individual targeted codeword failure count and the current count of failing codewords;
selecting, from the plurality of data tables, a select data table based on the plurality of difference values; and
decoding an individual failing codeword of a select page the plurality of pages using a decode process and LLR data from the select data table.
